(19) United States
(12) Patent Application Publication
(10) Pub. No.: US 2008/0306786 A1
(43) Pub. Date: Dec. 11, 2008

(54) License management tool to monitor and analyze license usage to determine need for additional licenses

(76) Inventors: Wayne J. Lonowski, Fort Collins, CO (US); Roy E. Anderson, Fort Collins, CO (US)

Correspondence Address: Gregory W. Osterloth;Holland & Hart, LLP, P.O. Box 8749, Denver, CO, 80201, US

(21) Appl. No.: 11/810,511

(22) Filed: Jun. 5, 2007

(51) Int. Cl. G06Q 10/00; G06F 17/30; G06F 17/40

(52) U.S. Cl. 705/7; 705/1; 707/104.1

(57) ABSTRACT

License management techniques for managing and analyzing license usage among license consumers.

### BACKGROUND OF THE INVENTION

The present invention relates generally to management of intellectual property licenses in a manufacturing environment, and more particularly to a method and apparatus for automatically managing, monitoring, and analyzing intellectual property license usage.

Equipment and machines are often now configured with communication means for communicating with the manufacturer, an authorized user, a base station, etc. For example, many computerized machines are equipped with a wireless transceiver for sending and receiving information and commands over a network.

Complex machines often provide capability that is protected by intellectual property such as patents. In some machines, protected capability may be activated by purchasing an appropriate license.

There are various means of activation of capability. For example, a user of a given machine may navigate within a browser to a website, purchase a license for the desired capability, receive an activation key, and download the activation key to the machine. The machine may be configured with activation detection software that processes the downloaded activation key and enables the capability that is to be unlocked with the activation key. Other capability activation means exist.

Remote activation of machine capability is useful in many applications, such as to allow machine upgrade over time as need for the capability, by the user, develops. In another example, remote capability activation is useful for allowing machine users to purchase capability only for the time that the capability is actually used—a concept known as “on-demand” or “per-use” activation.

With the proliferation of patents filed and issued over the last decades, it is rare in even a relatively simple machine that at least some aspect of the machine is not protected by at least one patent. A complex machine, such as an industrial integrated circuit tester, may utilize literally thousands of intellectual property protected components or techniques, and for this reason, among others, these machines are typically very expensive. In order to utilize many of the components or techniques that the machine is capable of, a user may have to purchase a license to use those components. In a complex machine, the number of different licenses, which protect different components or processes covered by the protected machine capabilities, may be quite large, and license management may become cumbersome. Furthermore, when the licenses of multiple machines, such as on a manufacturing floor, are brought under the same management system, the license management problem may become unwieldy.

In the past, license management was performed manually, for example, by maintaining a spreadsheet which records which licenses are activated, their expiration dates, which machines they apply to, etc. In more sophisticated implementations, licenses may be managed using computerized database systems that are developed and maintained by the different respective users/customers. However, while storage of the license information is computerized, the license maintenance, and activation of protected capability on machines, is still performed manually—that is, the content of the database must still be analyzed by a technician to determine which machines get which licenses, and when. Furthermore, there is no automated technique for collecting and analg information about the usage of the licenses, and consequently no automated technique for determining when, and for which machines, new licenses are needed or which licenses should not be renewed due to low use. This customized, non-standard, non-supported approach is inefficient and expensive, and can become difficult to use as the number of licenses increases. In addition, these approaches make it difficult to understand the usage pattern, or to anticipate the need for additional licenses. Bearing in mind the high costs of such sophisticated machinery, the company paying for use of the machine cannot afford to let it sit idle for lack of licenses. Accordingly, machine owners/users tend to overbuy licenses, which effectively increases the cost of use of the machine.

Accordingly, it would be desirable to have an automated technique that manages licenses, analyzes their frequencies of use, and can assist in determining the number and type of licenses needed at certain times, and number and types of licenses that need not be renewed. It would also be desirable that, given information about a specific manufacturing cycle, the management system could recommend, or even automatically handle, the purchasing and non-renewal of the various licenses required during the manufacturing cycle.

### SUMMARY OF THE INVENTION

An embodiment of the invention includes a license management utility for at least one license consumer configured with at least one protected capability that may be enabled for use by obtaining a valid license, comprising a license registration utility that records licenses held by the at least one license consumer in a license database, and a license analysis utility that analyzes license usage of the licenses recorded in the license database and stores the license usage analysis

An embodiment of the invention includes a method for managing licenses for at least one license consumer configured with at least one protected capability that may be enabled for use by obtaining a valid license, the method comprising the steps of recording licenses held by the at least one license consumer in a license database, monitoring usage of the licenses recorded in the license database, analyzing the license usage of the licenses recorded in the license database, and performing at least one of storing the license usage analysis and generate a report containing the license usage analysis

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an exemplary embodiment of a license management system;

FIG. 2 is a flowchart of an exemplary embodiment of a method for managing licenses for at least one license consumer configured with at least one protected capability; and

FIG. 3 is a flowchart of an exemplary embodiment of a method for allocating a limited number of licenses among a plurality of license consumers.

### DETAILED DESCRIPTION

For purposes of the invention, the term “license consumer” refers to any equipment, machine, computer, or other physical device or software executing on a computer that includes one or more protected capabilities.

For purposes of the invention, the term “protected capability” refers to any component or process of a license consumer that requires a license to enable the functionality or the component or process on the license consumer.

Embodiments of the invention include a license management utility, which may be in the form of software stored in computer readable memory and executed by a processor, or may be in the form of hardware. The license management utility monitors and analyzes usage of licenses registered with the license management utility. A variety of statistics and trend analyses may be applied to alert the user when new licenses are required and/or to predict a future need for licenses. This tool could also be tied to the production planning system, to alert the user to specific license requirements within the production planning timeframe. The tool could also be tied to web-based license ordering systems to automatically purchase licenses as needed.

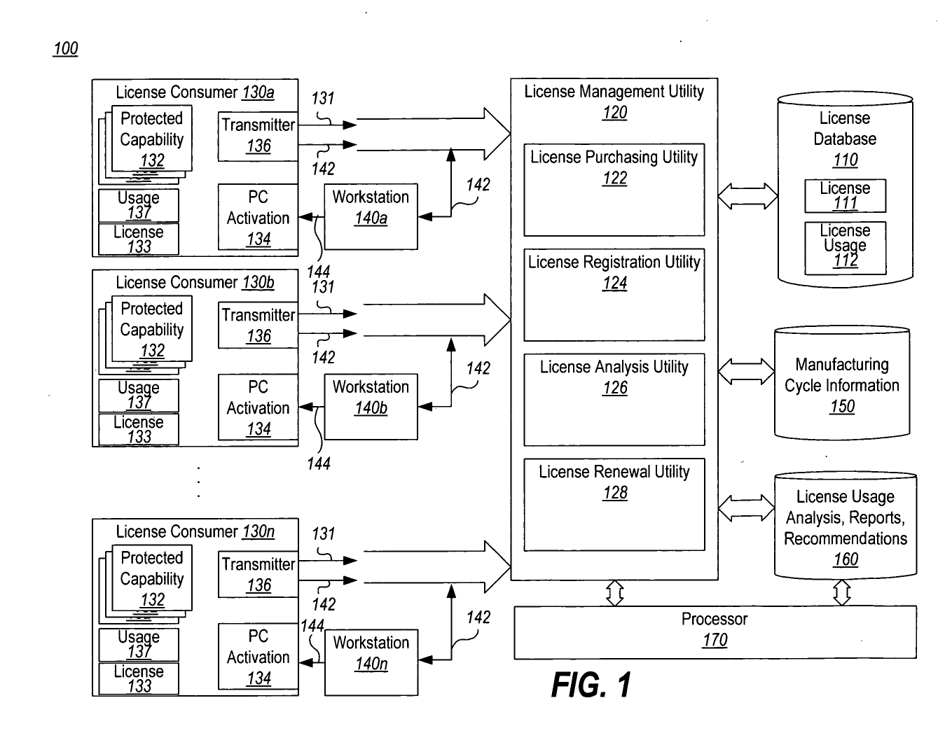

Turning now to the drawings, FIG. 1 is a block diagram of a license management system 100. As shown, the license management system 100 includes a license database 110, a license management utility 120, one or more license consumers 130a, 130b, 130n.

The license consumers 130a, 130b, 130n, each are configured with protected capability 132 that may be enabled by obtaining a valid license for the protected capability. The protected capability may be the same or different in any of the license consumers 130a, 130b, 130n. Protected capability 132 may be any functionality of the license consumer that requires a license and that may be enabled for use by obtaining a valid license. For example, in an integrated circuit tester, the base machine may operate at a certain speed. The base machine may also include high-speed capability which allows the tester to operate at a higher speed. The high-speed capability may be included in the base tester, but may be protected capability that can only enabled by obtaining a valid license for the high-speed capability. In another example, the base tester may be configured with analog testing capability that requires a license to enable its functionality for the user. There may be many more such examples in any one machine.

In order to automatically enable protected capability within a machine, the license consumers 130a, 130b, 130n may also include protected capability activation means 134. For example, the protected capability activation means 134 may comprise a relay that may be switched between an enabled position and a disabled position which is switched by entering a valid activation key in a graphical user interface activation dialog. In another example, the protected capability activation means 134 may be a software switch implemented as a boolean variable that when set to a first logical value enables the protected capability, and when set to a second logical value disables the protected capability.

The license consumers 130a, 130b, 130n may interface with a user by way of a workstation 140a, 140b, 140n. The workstation 140a, 140b, 140n, is a computer or terminal that includes a monitor and user input devices such as a keyboard, a mouse, and/or storage device readers.

In one embodiment, a graphical user interface (GUI) is presented to a user on the display screen of the license consumer's workstation monitor. The GUI presents one or more dialogs that allow the user to input a request for a license for specified protected capability. The GUI receives the input request and collects other information such as serial number of the machine, purchase and payment information, desired duration of use, etc. The GUI may also provide a protected capability activation dialog which allows a user to enter an activation key to turn on protected capability, as discussed above.

The license management utility 120 may include a license purchase utility 122 which handles the purchasing and validation of the license purchase information 142, and which may itself generate, or work with another utility to generate, a license and an associated protected capability activation key 144 which may be used to enable the licensed protected capability in a given license consumer 130a, 130b, 130n. The newly generated license and associated license consumer information is stored in the license database 110.

The license management utility 120 may also include a license registration utility 124 that automatically registers, and validates, existing licenses 131 of license consumers 130a, 130b, 130n with the license management utility 120. For example, when a license consumer 130a, 130b, 130n comes online (such as at power up or during a reboot process), the license consumer may contact the license management utility 120. The license registration utility 124 validates any licenses previously purchased for the license consumer and ensures that they are registered and recorded in the license database 110. Thus, when a license consumer 130a, 130b, 130n is first purchased, the seller may configure the license consumer with purchased capability. The particular configuration may store license information associated with the required licenses for the configured protected capability within the license consumer itself (for example, in non-volatile memory 133), or may store it at a remote site such as the manufacturer's registration site (which may be accessed by the license registration utility 124). When the user brings the purchased license consumer 130a, 130b, 130n online for the first time, the user may manually register the machine with the license management utility 120. In this regard, the user may access a regn dialog in the GUI presented at a workstation 140a, 140b, 140n, which interfaces with the license registration utility 124 to effect registration of the purchased licenses for the particular license consumer in the license database 110. Alternatively, when the license consumer is brought online for the first time, the license consumer may automatically search for the license management utility 120 and automatically register its licenses with the license management utility 120. In yet another embodiment, the license management utility 120 may actively search for license consumers 130a, 130b, 130n within a predefined area, and automatically register any found license consumers.

The license management utility 120 may also include a license analysis utility 126. The license analysis utility 126 keeps track of license usage by the various license consumers 130a, 130b, 130n.

In one embodiment, the license consumers 130a, 130b, 130n log and locally maintain license usage information 137, and the license analysis utility 126 periodically contacts the license consumers 130a, 130b, 130n and downloads the usage information. In another embodiment, registered license consumers 130a, 130b, 130n automatically send license usage event messages to the license management utility 120 whenever actions are performed at the license consumer 130a, 130b, 130n that utilizes, or attempts to utilize, a licensed protected capability.

The license analysis utility 126 may analyze the usage information (such as license usage events) associated with the various licenses in the license database 110, and may perform trend analysis to detect trends in license usage. For example, the license analysis utility 126 may detect a trend in increased or decreased usage of a particular license. The license analysis utility 126 may be configured to generate reports detailing the trend analysis from which useful information such as an indication that more or less licenses of different types are needed may be extracted. The license analysis utility 126 may also be configured to generate a signal or an alarm to indicate that another license is needed. The signal or alarm may trigger the automatic purchase of another license.

The license management utility 120 may includes a license renewal utility 128 which automatically renews licenses that are up for renewal using previously obtained purchase and payment information. The license analysis utility 126 may be configured to trigger the license renewal utility 128 to automatically renew, or not renew, licenses based on analysis of the license usage data by the license analysis utility 126.

The license management utility 120 may be used to allow protected capabilities within a given license consumer 130a, 130b, 130c, or even multiple license consumers 130a, 130b, 130, to share licenses. For example, suppose a manufacturing facility owns a number of integrated circuit testers (i.e., license consumers), but purchases fewer licenses than testers for certain protected capabilities that are known to be used only intermittently. The licenses may be registered with the license management utility 120. The license management utility 120 may be configured to receive requests for licenses of a particular license type and manage the allocation of these licenses to the testers in an on-demand fashion. For example, the license management utility 120 may receive a request for a license of a particular license type (e.g., an analog module license). The license management utility 120 may determine whether there are any such licenses (e.g., for an analog module) that are authorized for use by the requesting license consumer and that are currently not in use by another authorized license consumer. If there are, the license management utility 120 may allocate the available license to the requesting license consumer. If not, the license management utility 120 may either queue the request and service the requests as the requested licenses become available (i.e., are not in use by other authorized license consumers), or may require the requesting license consumer to poll the license management utility for availability of the requested license.

The license analysis utility 126 may also track frequency of occurrences, or even idle time, of managed consumers that are idle due to waiting for an available license. For example, suppose a manufacturing facility owns a number of integrated circuit testers with fewer licenses than testers for certain protected capabilities. Suppose further that a first subset of these integrated circuit testers are used to perform tests which require a first subset of the protected capability of the testers, and that a second different subset of these integrated circuit testers are used to perform tests which require a second subset of the protected capability of the testers. Suppose further that there is at least some overlap of the protected capability in the first and second protected capability subsets, but, again, there are not enough licenses to cover every machine in both the first and second subsets of the integrated circuit testers. In this scenario, some of the integrated circuit testers will sit idle while waiting for a license to become available upon release of the license by another tester. When a license consumer 130a, 130b, 130c sits idle due to waiting for an available license, it may generate an event indicating this “idle” or “waiting” condition that is collected by the license management utility 120. The license management utility 120 may store this event, for example as data associated with the particular license in the license database 110. These type of events in the license usage information may be used by the license analysis utility 126 to identify various license types for which the demand is higher than the current number of licenses. A demand threshold may be set in the license analysis utility 126, which when the frequency of occurrences of “wait” conditions exceeds the threshold, results in the generation of a signal or alarm to indicate that more licenses of the particular license type associated with the condition, should be purchased. The alarm may trigger automatic purchase of the license.

In one embodiment, the license analysis utility 126 is a statistical process control software package that includes trend analysis features, which are well known in the art and are commonly available.

Similarly, the license usage information may be used by the license analysis utility 126 to identify various licenses that sit idle due to infrequent use, which may result in the generation of a signal indicating recommendation of non-renewal of a number of licenses. The signal may trigger automatic non-renewal through the license renewal utility 128.

In one embodiment, the license management system 120 may also provide analysis and management capability for optimizing the timing of purchasing, renewals, and non-renewals of licenses specific to a particular manufacturing cycle. During normal operation, the license analysis utility 126 may access a specified manufacturing cycle information storage 150 which contains manufacturing cycle information such as number of testers in use, volume of manufacturing run (i.e., number of pieces to manufactured and/or tested), types of tests to be run, which licenses are required to executing each different type of test, historical information such as average time different types of tests take to execute), etc. The license analysis utility 120 may analyze the information, determine which tests overlap at which time in requiring particular protected capability, and generates a report with recommendations of which licenses to purchase when, and when to renew or not renew the licenses. The license analysis utility 120 may be configured to automatically handle the purchasing and non-renewal of the various licenses required during the manufacturing cycle.

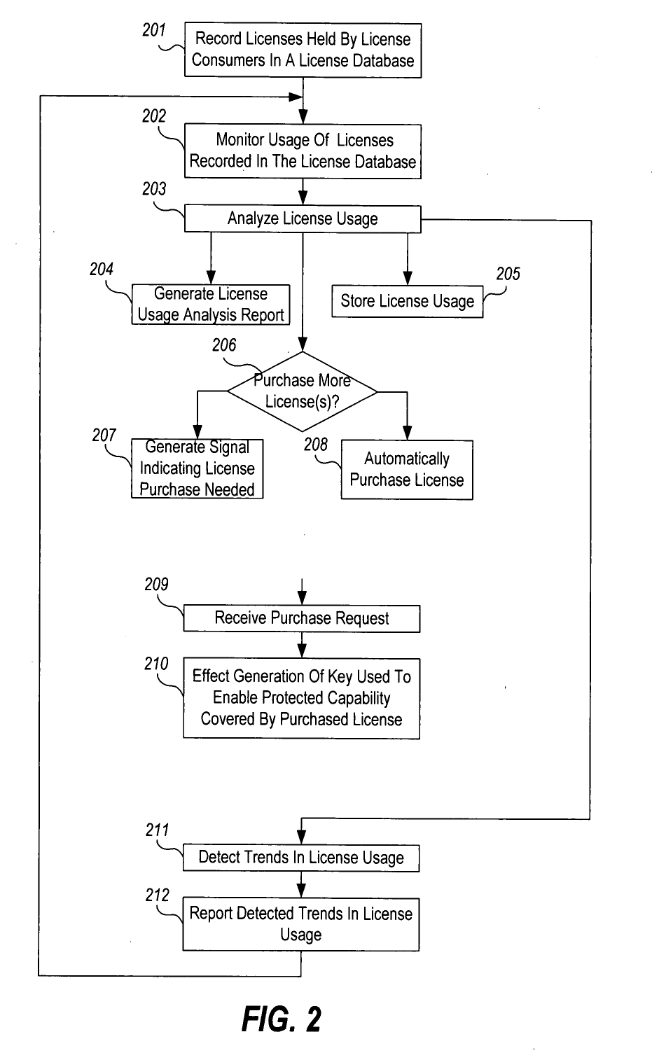

FIG. 2 is a flowchart illustrating an exemplary embodiment of a method for managing licenses for at least one license consumer configured with at least one protected capability that may be enabled for use by obtaining a valid license. As illustrated, the method comprises the steps of recording licenses held by the at least one license consumer in a license database (step 201). This step may be performed automatically, and may include validation of existing licenses of license consumers. The method also includes the step of monitoring usage of the licenses recorded in the license database (step 202), analyzing the license usage of the licenses recorded in the license database (step 203). The license usage analysis may be stored (step 204) and/or a report containing the license usage analysis may be generated (step 205).

The method 200 may further comprise determining whether at least one additional license should be purchased (step 206). When the determination is that at least one additional license should be purchased, a signal indicating that the at least one additional license should be purchased may be generated (step 207). Alternatively, the at least one additional license may be automatically purchased (step 208).

The method 200 may further comprise the steps of receiving a request and valid purchase criteria such as valid payment information for purchase of a license for a given protected capability (step 209), and effecting generation of a valid key used to enable the given protected capability covered by the purchased license (step 210).

The method 200 may further comprise performing trend analysis on usage events associated with the various licenses in the license database to detect trends in license usage (step 211), and reporting detected trends in license usage (step 212).

The method 200 may further comprise automatically renewing (step 213), or not renewing (step 220), licenses based on the license usage analysis (step 214). The method 200 may further comprise identifying, from the license usage analysis, various licenses having low usage (step 215), identifying, from the license usage analysis, that too many licenses of a particular license type exist for the amount of use (step 216), and generating a signal representing a recommendation of renewal or non-renewal of at least one license of the particular license type (step 217).

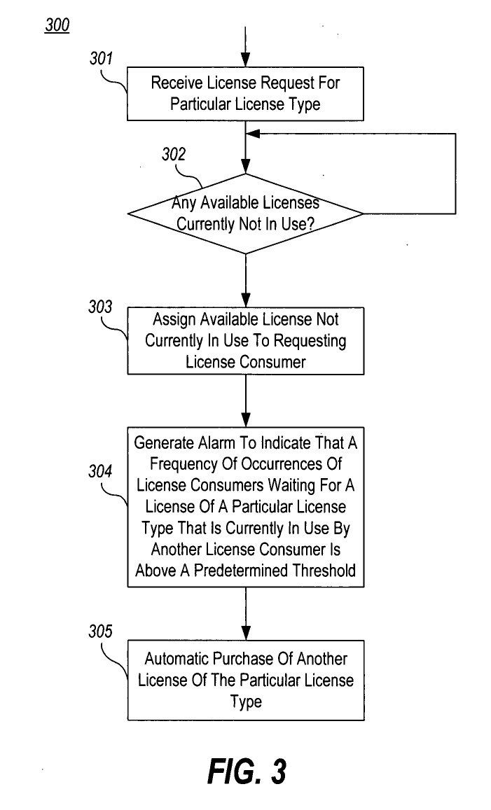

FIG. 3 is a flowchart illustrating an exemplary embodiment of a method 300 for allocating a limited number of licenses among a plurality of license consumers. The method 300 comprises receiving requests for licenses of a particular license type (step 301), determining whether any available licenses of the particular license type which may be used by the requesting license consumer are currently not in use (step 302), assigning an available license characterized by the requested license type to the requesting license consumer when the available license is not currently in use (step 303), and generating an alarm to indicate that a frequency of occurrences of license consumers waiting for a license of a particular license type that is currently in use by another license consumer is above a predetermined threshold (step 304). The alarm may further trigger an automatic purchase of another license of the particular license type (step 305).

Described in detail above are embodiments of a license management system which allows efficient monitoring of license usage, management of what licenses to purchase and when, and what licenses to renew and not renew. The license management techniques may be utilized to forecast the number of different licenses needed for future uses of the license consumers.

Those of skill in the art will appreciate that the invented method and apparatus described and illustrated herein may be implemented in software, firmware or hardware, or any suitable combination thereof. For example, in one embodiment, the license management utility 120 and its components including the license purchasing utility 122, the license registration utility 124, the license analysis utility 126, and the license renewal utility 128, are each implemented as software, which when executed by a processor 170, implement the functionality described above with respect to each element.

Those of skill in the art will further appreciate that the method and apparatus of the invention may be implemented as a computer-readable medium which stores computer-readable program instructions, which, when executed by a processor, implement the functionality described above with respect to each element.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A license management utility for at least one license consumer configured with at least one protected capability that may be enabled for use by obtaining a valid license, comprising:
a license registration utility that records licenses held by the at least one license consumer in a license database; and
a license analysis utility that analyzes license usage of the licenses recorded in the license database and stores the license usage analysis.

2. The license management utility of claim 1, wherein the license analysis utility determines whether at least one additional license should be purchased and generates a signal indicating that the at least one additional license should be purchased.

3. The license management utility of claim 1, wherein the license analysis utility determines whether at least one additional license should be purchased and automatically purchases the at least one additional license.

4. The license management utility of claim 1, comprising:
a license purchase utility which handles purchasing of a license for a given protected capability, and effects generation of a key used to enable a protected capability covered by the purchased license.

5. The license management utility of claim 1, wherein the license analysis utility performs trend analysis on usage events associated with the various licenses in the license database to detect trends in license usage, and reports detected trends in license usage.

6. The license management utility of claim 5, wherein:
the license management utility receives requests for licenses of a particular license type, determines whether any available licenses of the particular license type which may be used by the requesting license consumer are currently not in use, and assigns an available license characterized by the requested license type to the requesting license consumer when the available license is not currently in use; and
the license analysis utility is configured to generate an alarm to indicate that a frequency of occurrences of license consumers waiting for a license of a particular license type that is currently in use by another license consumer is above a predetermined threshold.

7. The license management utility of claim 6, wherein the alarm triggers an automatic purchase of another license of the particular license type.

8. The license management utility of claim 1, wherein the license analysis utility comprises a license renewal utility which automatically renews licenses that are up for renewal.

9. The license management utility of claim 1, wherein the license analysis utility comprises a license renewal utility which automatically renews, or chooses not to renew, licenses based on the license usage analysis.

10. The license management utility of claim 1, wherein the license analysis utility identifies, from the license usage analysis, various licenses having low usage.

11. The license management utility of claim 1, wherein the license analysis utility identifies, from the license usage analysis, that too many licenses of a particular license type exist for the amount of use, and generates a signal representing a recommendation of non-renewal of at least one license of the particular license type.

12. A method for managing licenses for at least one license consumer configured with at least one protected capability that may be enabled for use by obtaining a valid license, the method comprising the steps of:
recording licenses held by the at least one license consumer in a license database;
monitoring usage of the licenses recorded in the license database;
analyzing the license usage of the licenses recorded in the license database; and
performing at least one of storing the license usage analysis and generate a report containing the license usage analysis.

13. The method of claim 12, comprising:
determining whether at least one additional license should be purchased; and
when the determination is that at least one additional license should be purchased, generating a signal indicating that the at least one additional license should be purchased.

14. The method claim 12, comprising:
determining whether at least one additional license should be purchased; and
when the determination is that at least one additional license should be purchased, automatically purchasing the at least one additional license.

15. The method of claim 12, comprising:
receiving a request and valid purchase criteria for purchase of a license for a given protected capability; and
effecting generation of a valid key used to enable the given protected capability covered by the purchased license.

16. The method of claim 12, comprising:
performing trend analysis on usage events associated with the various licenses in the license database to detect trends in license usage; and
reporting detected trends in license usage.

17. The method of claim 16, comprising:
receiving requests for licenses of a particular license type;
determining whether any available licenses of the particular license type which may be used by the requesting license consumer are currently not in use;
assigning an available license characterized by the requested license type to the requesting license consumer when the available license is not currently in use; and
generating an alarm to indicate that a frequency of occurrences of license consumers waiting for a license of a particular license type that is currently in use by another license consumer is above a predetermined threshold.

18. The method of claim 17, wherein the alarm triggers an automatic purchase of another license of the particular license type.

19. The method of claim 12, comprising:
automatically renewing, or not to renewing, licenses based on the license usage analysis.

20. The method of claim 12, comprising:
identifying, from the license usage analysis, various licenses having low usage;
identifying, from the license usage analysis, that too many licenses of a particular license type exist for the amount of use; and
generating a signal representing a recommendation of renewal or non-renewal of at least one license of the particular license type.
